(19) United States
(12) Patent Application Publication
(10) Pub. No.: US 2009/0323097 A1
(43) Pub. Date: Dec. 31, 2009

(54) INFORMATION PROCESSING APPARATUS, CONTROL METHOD OF IMAGE PROCESSING SYSTEM AND COMPUTER PROGRAM THEREOF

(75) Inventor: Hiroko Iizuka, Hachioji-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/473,583

(22) Filed: May 28, 2009

(30) Foreign Application Priority Data
Jun. 26, 2008 (JP) 2008-167875

(51) Int. Cl. G06K 15/02

(52) U.S. Cl. 358/1.14

(57) ABSTRACT

A printing system and its control method are provided allowing flexible function restrictions during print job execution even with an image forming apparatus incapable of highly advanced functions such as interpreting functional restriction information, etc. The invention is applied to a printing system where an information processing apparatus and a plurality of image forming apparatuses are connected via a network. The information processing apparatus transmits a print job assigned access restriction information, the information indicating whether or not to authorize the execution of the print job, only when an image forming apparatus or output destination of the print job is capable of interpreting such access restriction information. When an image processing apparatus is not capable of interpreting access restriction information, the information processing apparatus deletes access restriction information, but reflects restriction contents of the information in the data for the print job, and transmits the resultant job.

### BACKGROUND OF THE INVENTION

1. Field of the Invention

The present invention relates to an information processing apparatus that restricts job execution, and a control method of an image processing system and computer program thereof.

2. Description of the Related Art

In recent years, as part of efforts to increase security for network equipment, great importance has been placed on function restrictions at the time of job execution, and various measures are taken to achieve it.

For example, Japanese Patent Laid-Open No. 2003-150336 has suggested an information processing apparatus or system that, when transmitting a print job to an image forming apparatus, acquires an authenticated print authorization ticket (function restriction ticket) from a server and transmits both the ticket and the print job to the image forming apparatus. Such a function restriction ticket describes what functions of an image forming apparatus are available to the user who issued the job. According to such a function restriction ticket, an image forming apparatus can flexibly restrict its functions at the time of execution of a print job.

However, such a conventional technique has the following problems. For example, the system described in Japanese Patent Laid-Open No. 2003-150336 is based on the premise that each image forming apparatus has highly advanced functions such as interpreting a function restriction ticket assigned to a print job, and the like. This limits those image forming apparatuses that are capable of executing such a print job from among the image forming apparatuses connected to a system. For instance, it is assumed that old-model image forming apparatuses or such image forming apparatuses that are affordably priced because they lack highly advanced functions do not have highly advanced functions such as interpreting a function restriction ticket, or the like. Those image forming apparatuses that do not have highly advanced functions such as interpreting a function restriction ticket or the like have a problem of difficulty in flexibly restricting their functions at the time of execution of a print job.

### SUMMARY OF THE INVENTION

The present invention enables realization of an information processing apparatus that allows flexible function restrictions at the time of job execution even with such an image processing apparatus that does not have highly advanced functions such as interpreting function restriction information or the like, and also a control method of an image processing system.

One aspect of the present invention provides an information processing apparatus in an image processing system where the information processing apparatus and a plurality of image processing apparatuses are connected to one another via a network, the information processing apparatus comprising: an assignment unit that assigns restriction information that restricts a job executed by an image processing apparatus to the job; and a first control unit that when an image processing apparatus has a function of interpreting the restriction information, transmits the job assigned the restriction information to the image processing apparatus, and when an image processing apparatus does not have a function of interpreting the restriction information, reflects restriction contents of the restriction information in data for the job and transmits the reflected job to the image processing apparatus.

Another aspect of the present invention provides an image processing apparatus in an image processing system where an information processing apparatus and a plurality of image processing apparatuses are connected to one another via a network, the image processing apparatus comprising: a reception unit that receives a device profile that includes information for requesting execution of a job from another apparatus connected to the network; and a control unit that when the another apparatus is an image processing apparatus that has a function of interpreting restriction information that restricts a job to be executed, transmits to the another apparatus a device profile that includes first identifying information for identifying first device information that allows use of a specific function of its own apparatus, and when the another apparatus is not an image processing apparatus that has a function of interpreting the restriction information, transmits to the another apparatus a device profile that includes second identifying information for identifying second device information that restricts the use of the specific function of its own apparatus.

Still another aspect of the present invention provides a control method for an image processing system where an information processing apparatus and a plurality of image processing apparatuses are connected to one another via a network, the control method being performed by the information processing apparatus and comprising: assigning restriction information that restricts a job executed by an image processing apparatus to the job; and performing control so that when an image processing apparatus has a function of interpreting the restriction information, a job assigned the restriction information is transmitted to the image processing apparatus, and when an image processing apparatus does not have a function of interpreting the restriction information, a job that reflects restriction contents of the restriction information in data for the job assigned the restriction information is transmitted to the image processing apparatus.

Still yet another aspect of the present invention provides a control method for an image processing system where an information processing apparatus and a plurality of image processing apparatuses are connected to one another via a network, the control method being performed by an image processing apparatus and comprising: receiving a request for a device profile that includes information for requesting execution of a job, from another apparatus connected to the network; and performing control so that when the another apparatus is an image processing apparatus that has a function of interpreting restriction information that restricts a job to be executed, a device profile that includes first identifying information for identifying first device information that allows use of a specific function of its own apparatus is transmitted to the another apparatus, and when the another apparatus is not an image processing apparatus that has a function of interpreting the restriction information, a device profile that includes second identifying information for identifying second device information that restricts the use of the specific function of its own apparatus is transmitted to the another apparatus.

Yet still another aspect of the present invention provides a computer-readable storage medium storing a computer program that causes a computer to execute a control method for an information processing apparatus in an image processing system where the information processing apparatus and a plurality of image processing apparatuses are connected to one another via a network, the control method comprising: assigning restriction information that restricts a job executed by an image processing apparatus to the job; and performing control so that when an image processing apparatus has a function of interpreting the restriction information, a job assigned the restriction information is transmitted to the image processing apparatus, and when an image processing apparatus does not have a function of interpreting the restriction information, a job that reflects restriction contents of the restriction information in data for the job assigned the restriction information is transmitted to the image processing apparatus.

Still yet another aspect of the present invention provides a computer-readable storage medium storing a computer program that causes a computer to execute a control method for an image processing apparatus in an image processing system where a plurality of image processing apparatuses are connected to one another via a network, the control method comprising: receiving a request for a device profile that includes information for requesting execution of a job, from another apparatus connected to the network; and performing control so that when the another apparatus is an image processing apparatus that has a function of interpreting the restriction information, a device profile that includes first identifying information for identifying first device information that allows use of a specific function of its own apparatus is transmitted to the another apparatus, and when the another apparatus is not an image processing apparatus that has a function of interpreting the restriction information, a device profile that includes second identifying information for identifying second device information that restricts the use of the specific function of its own apparatus is transmitted to the another apparatus.

Further features of the present invention will be apparent from the following description of exemplary embodiments with reference to the attached drawings.

### BRIEF DESCRIPTION OF THE DRAWINGS

FIG. 1 illustrates a configuration of a printing system 100 according to a first exemplary embodiment.

FIG. 2 is a block diagram illustrating an exemplary hardware configuration of a client PC 101 according to the first exemplary embodiment.

FIG. 3 is a block diagram illustrating an exemplary hardware configuration of an image forming apparatus according to the first exemplary embodiment.

FIG. 4 is an explanatory diagram illustrating the operation of the printing system 100 according to the first exemplary embodiment.

FIG. 5 illustrates a software configuration of the client PC 101 according to the first exemplary embodiment.

FIG. 6A illustrates a functional configuration of a security-equipped image forming apparatus according to the first exemplary embodiment.

FIG. 6B illustrates another functional configuration of a security-equipped image forming apparatus according to the first exemplary embodiment.

FIG. 7 is a flowchart illustrating a processing procedure of the client PC 101 according to the first exemplary embodiment.

FIG. 8 is a flowchart illustrating a processing procedure of a non-security-equipped image forming apparatus according to the first exemplary embodiment.

FIG. 9 illustrates a structure of an SNMP packet according to the first exemplary embodiment.

FIG. 10 shows an example of a job and an ACT that are output from a client PC to the outside.

FIG. 11 illustrates a flow of information among apparatuses in the printing system 100 according to a second exemplary embodiment.

FIG. 12 is a flowchart illustrating a processing procedure of the client PC 101 according to the second exemplary embodiment.

FIG. 13 is a flowchart illustrating a processing procedure of a security-equipped image forming apparatus 102 according to the second exemplary embodiment.

FIG. 14 is a flowchart illustrating a processing procedure of an image forming apparatus for transmission of a print job according to a third exemplary embodiment.

FIG. 15 is a flowchart illustrating a processing procedure of an image forming apparatus for transmission of a print job according to a fourth exemplary embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Exemplary Embodiment

Configuration of Printing System

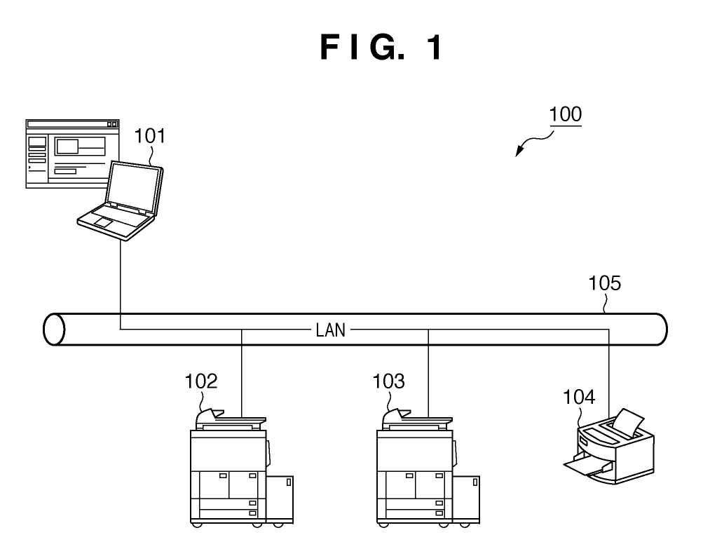

Now, a first exemplary embodiment is described with reference to FIGS. 1 to 10. FIG. 1 illustrates a configuration of a printing system 100 as an example of an image processing system according to the first exemplary embodiment. The printing system 100 includes a client PC 101 and image forming apparatuses 102, 103, and 104.

The client PC 101 is a client computer that is an information processing apparatus. The client PC 101 generates and outputs a print job via a LAN 105 to an external apparatus. The term “client PC” as used herein is just a name given for convenience of description, and it is actually constructed using a typical personal computer. The image forming apparatuses 102 to 104 are one example of an image processing apparatus; they process various kinds of input jobs to form an image on a recording material or the like. Each apparatus is connected to other apparatuses via the LAN(local-area network) 105 and is capable of communicating data with the others.

In the following description, a LAN is given as an example of a communication medium that supports communication between or among apparatuses; however, the present invention is not limited thereto. Any other communication medium such as a telephone line network, an Internet communications network, a WAN (Wide Area Network) constructed of a plurality of LANs, or a wireless LAN that conforms to a standard such as IEEE802.11b or the like may be adapted as a communication medium used in the present invention. Also, a local interface such as IEEE1284 or USB (Universal Serial Bus) may be adapted as a communication medium.

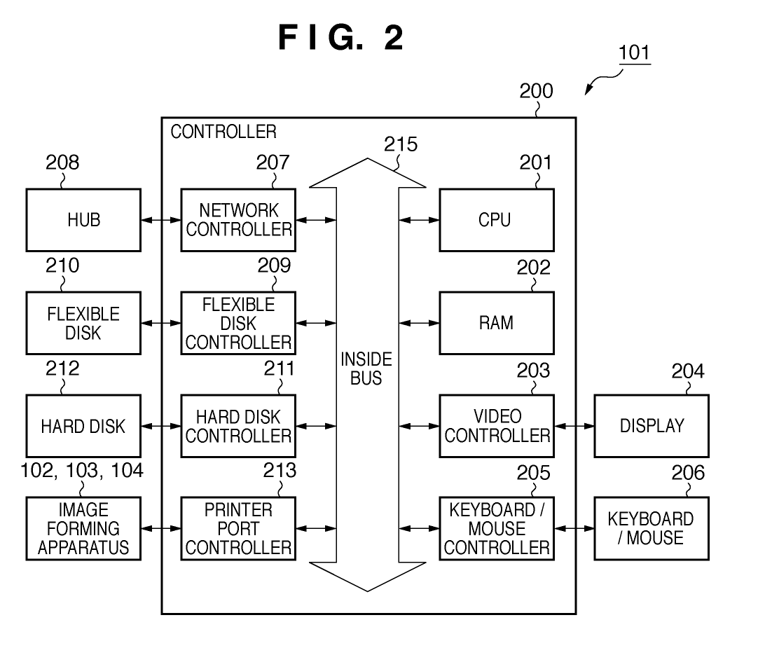

Hardware Configuration of Client PC Next, a hardware configuration of the client PC 101 illustrated in FIG. 1 is described with reference to FIG. 2. FIG. 2 is a block diagram illustrating an exemplary hardware configuration of the client PC 101 according to the first exemplary embodiment. The hardware configuration of the client PC 101 includes a controller 200. The controller 200 is, as illustrated in FIG. 2, connected to a display 204, a keyboard/mouse 206, a hub 208, a flexible disk (FD) 210, and an HDD (hard disk drive) 212. The controller 200 is further connected via the LAN 105 to the image forming apparatuses 102, 103, and 104.

The controller 200 includes a CPU 201, a RAM 202, and a video controller 203. The controller 200 further includes a keyboard/mouse controller 205, a network controller 207, a flexible disk controller 209, a hard disk controller 211, and a printer port controller 213.

The CPU 201 executes programs stored in the RAM 202 or the like. Such programs include an operating system (OS), a printer driver that causes an image forming apparatus to perform printing, and an application program for generating data to be printed with a printer driver. Cooperative processing of such programs allows the execution of various kinds of jobs. The CPU 201 also loads, into the RAM 202, a program or data that is stored in the FD 210 or the HDD 212 as a nonvolatile memory and, on the other hand, stores the contents of the RAM 202 in the FD 210, the HDD 212, or the like.

The flexible disk controller 209 and the hard disk controller 211 control reading/writing of data from/into a storage medium. The video controller 203 outputs rendering information to the display 204 connected thereto. The keyboard/mouse 206 is an input device that is used to input various kinds of data. Input from such an input device is transmitted via the keyboard/mouse controller 205 and processed through a program operating on the CPU 201.

The network controller 207 is connected via the hub 208 to the LAN 105 in FIG. 1 to communicate with apparatuses over the network. It is also capable of directly communicating with the image forming apparatuses 102, 103, and 104 that are connected to a printer port under the control of the printer port controller 213. The CPU 201, the RAM 202, and each controller are each connected to an internal bus 215 and exchange control information or data among devices.

Hardware Configuration of Image Forming Apparatus

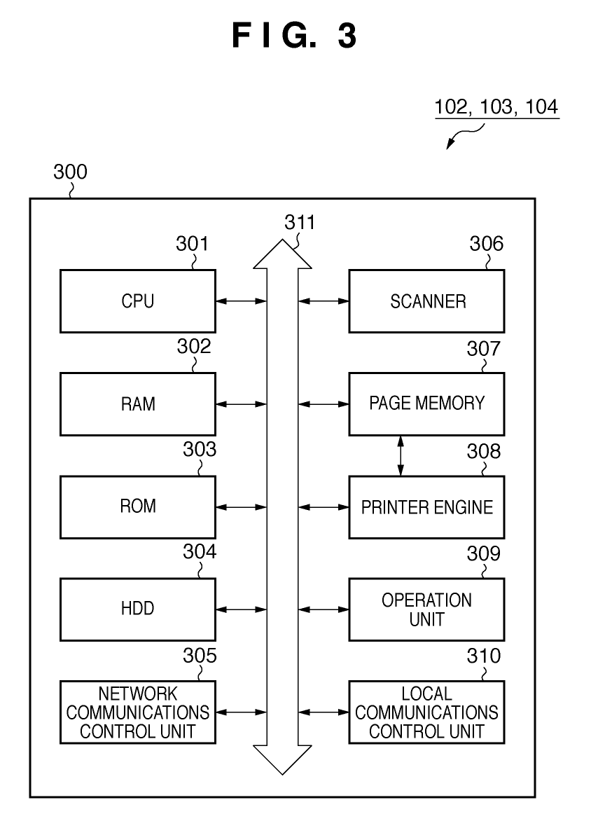

Next, hardware configurations of the image forming apparatuses 102, 103, and 104 in FIG. 1 are described with reference to FIG. 3. FIG. 3 is a block diagram illustrating an exemplary hardware configuration of an image forming apparatus according to the first exemplary embodiment. Herein, a common configuration of the image forming apparatuses 102, 103, and 104 is described. The hardware configuration of the image forming apparatuses 102, 103, and 104 includes a controller 300.

The controller 300 includes a CPU 301, a RAM 302, a ROM 303, an HDD 304, a network communications control unit 305, a scanner 306, a page memory 307, a printer engine 308, an operation unit 309, and a local communications control unit 310. These devices are each connected to a system bus 311 and exchange control information or data among devices.

The CPU 301 performs centralized control of access to each device connected to the system bus 311, based on a control program or the like stored in the ROM 303 or the HDD 304. It also controls the function of expanding page description language that is received from the outside into image data in such a format that the printer engine 308 can print it, and of outputting an image signal to the page memory 307 that is connected via a video I/F (not shown).

The RAM 302 is a RAM that serves as a main memory of the CPU 301, a work area, or the like. Output information (or image signals) stored in the page memory 307 is printed on a recording material with the printer engine 308. The network communications control unit 305 exchanges various kinds of data with an external apparatus via the LAN 105. Similarly, the local communications control unit 310 exchanges various kinds of data with an external apparatus via a local communications destination. The operation unit 309 includes a display panel, a keyboard, and the like and is configured to give information to an operator or allow an operator to input an instruction.

Operation of Printing System

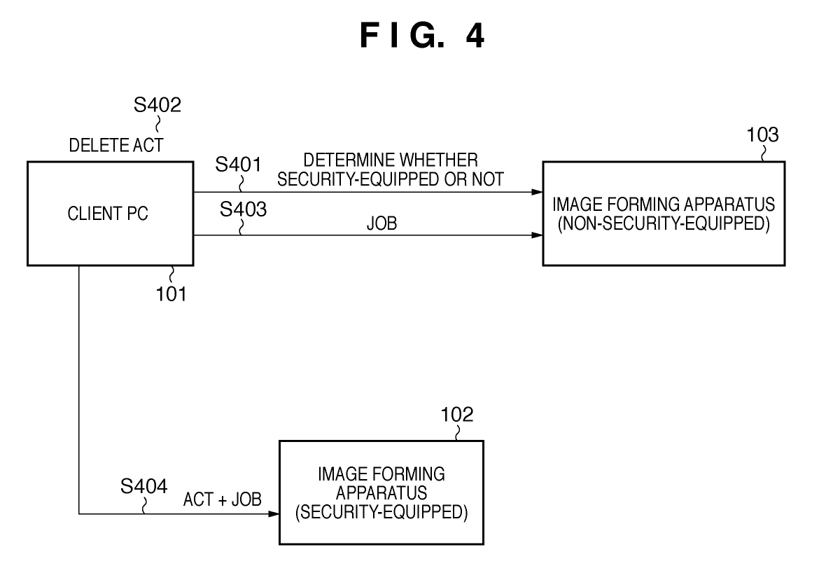

Now, the operation of the printing system 100 is described with reference to FIG. 4. FIG. 4 is an explanatory diagram illustrating the operation of the printing system 100 according to the first exemplary embodiment. Now, a flow of information among apparatuses in the printing system 100 is described. Described herein is the operation performed in the case where printing is executed from the client PC 101.

First of all, when making a print request, the client PC 101 generates a print job assigned an ACT (Access Control Token) as access restriction information for giving authorization to execute a print job or prohibiting part of the execution on a user-by-user basis. When a user logs in to the LAN 105 using the client PC 101, a user management server on the LAN 105 is accessed, from which an ACT that is specific to the currently logged-in user is then acquired. Of course, any other method may be used to acquire a user-specific ACT. Alternatively, instead of an ACT directly describing restriction contents, based on user information included in an ACT, an image forming apparatus that receives such an ACT may acquire information about restriction contents from a user management server. A print job includes image data to be printed, job settings (whether printing is single-sided or double-sided, whether stapling of printed recording paper is necessary or not, etc.,) and the like. At this time, restriction information included in an ACT has precedence over job settings. In other words, it is prohibited to execute a job in such job settings that define contents that exceed the restriction contents specified by an ACT. Then, in step S401, the client PC 101 determines whether or not a security-equipped image forming apparatus is designated as a final output destination of a job. Here, when a non-security-equipped image forming apparatus 103 is designated, the client PC 101 deletes an ACT from a print job in step S402 and transmits a print job with an ACT deleted therefrom to the image forming apparatus 103 in step S403. The image forming apparatus 103 performs such a print job received in step S403. On the other hand, when the security-equipped image forming apparatus 102 is designated as an output destination of a job, then in step S404, the client PC 101 transmits a print job assigned an ACT to the image forming apparatus 102 without deleting the ACT.

In this way, the printing system according to the present exemplary embodiment determines whether or not to transmit a print job assigned an ACT, according to the function of an image forming apparatus, that is, according to whether or not an image forming apparatus is capable of interpreting an ACT.

Software Configuration of Client PC

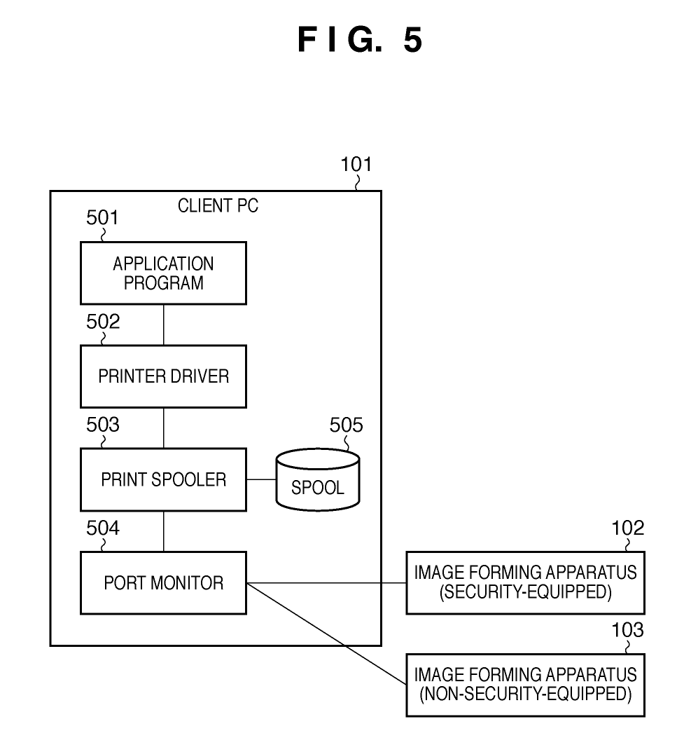

Next, the operation of the client PC 101 when making a print request is described with reference to FIG. 5. FIG. 5 illustrates a software configuration of the client PC 101 according to the first exemplary embodiment. The software configuration of the client PC 101 includes an application program 501, a printer driver 502, a print spooler 503, a port monitor 504, and a spool 505.

First, when a user makes a print request after designating an image forming apparatus through the application program 501, the printer driver 502 generates a print job assigned an ACT. The generated print job with an ACT is then temporarily stored via the print spooler 503 on the spool 505. The port monitor 504 performs processing such as transmitting and receiving a job through a network, acquiring the status of an image forming apparatus, and the like. When the port monitor 504 determines that an image forming apparatus designated as an output destination of a print job is capable of receiving a job, in response to this, the print spooler 503 fetches a temporarily stored print job from the spool 505 and transmits the fetched job to the image forming apparatus.

Functional Configuration of Security-Equipped Image Forming Apparatus

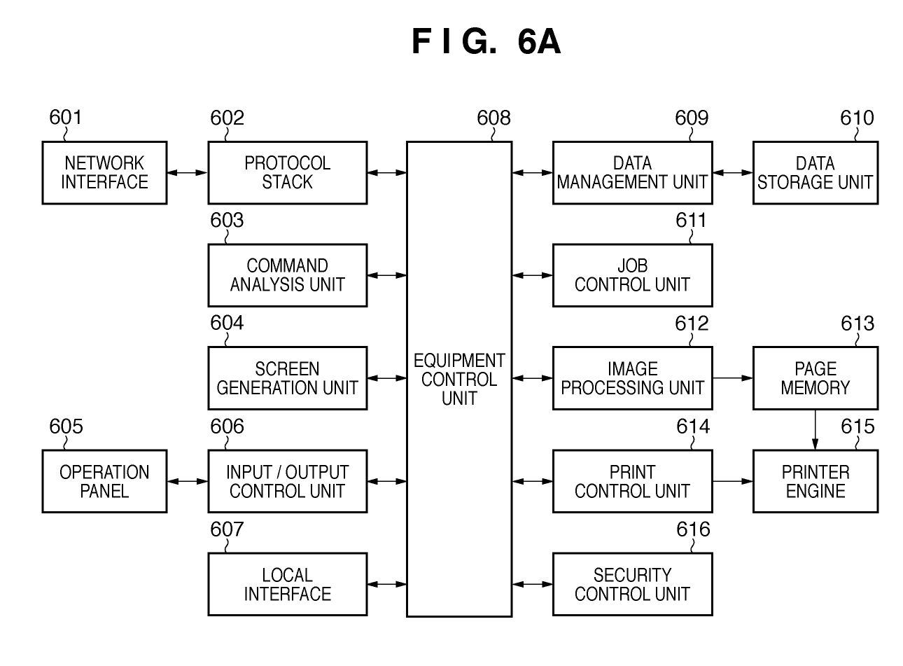

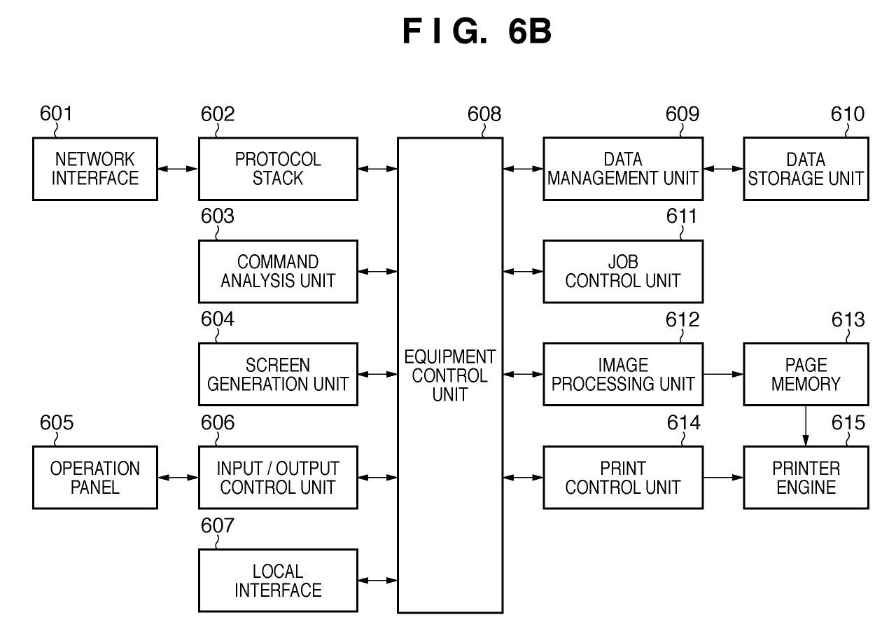

Referring next to FIG. 6A, a security-equipped image forming apparatus is described. FIG. 6A illustrates a functional configuration of a security-equipped image forming apparatus according to the first exemplary embodiment. The term “security-equipped image forming apparatus” as used herein refers to an image forming apparatus that is capable of interpreting access restriction information according to the present exemplary embodiment. In the drawing, some hardware blocks are also shown for convenience of description.

A security-equipped image forming apparatus includes a network interface 601, a protocol stack 602, a command analysis unit 603, a screen generation unit 604, an operation panel 605, an input/output control unit 606, a local interface 607, and an equipment control unit 608. The image forming apparatus further includes a data management unit 609, a data storage unit 610, a job control unit 611, an image processing unit 612, a page memory 613, a print control unit 614, a printer engine 615, and a security control unit 616.

The network interface 601 is connected to the LAN 105 and communicates data with other apparatuses connected in a similar fashion to the LAN 105. Data received via the network interface 601 is assembled according to each protocol layer by the protocol stack 602 and transmitted, under the control of the equipment control unit 608, to the command analysis unit 603 where the contents of data are analyzed.

The image forming apparatus further includes, in addition to the network interface 601, the local interface 607 such as IEEE1284, USB, or the like, and when connected via the local interface 607 to an information processing apparatus, it becomes capable of accepting a processing request from the connected information processing apparatus. Data received via this local interface 607 is also transmitted, under the control of the equipment control unit 608, to the command analysis unit 603 where the contents of the data are analyzed.

When the analysis by the command analysis unit 603 indicates that the received data is identified as a print job with an ACT, the security control unit 616 checks for the restriction contents of the job specified by the ACT. This security control unit 616 has a print-job-attribute restriction function such as restricting, degenerating, or controlling the execution of functions that are used at the time of execution of a print job, based on the restriction contents specified by the ACT, and providing notification of such restrictions to downstream devices.

On the other hand, when the analysis by the command analysis unit 603 indicates that the received data is identified as a print job with no ACT (e.g., page description language data, print setting data, or the like), the data management unit 609 stores that data into a print queue that occupies a given area of the data storage unit 610.

The job control unit 611 monitors the print queue in the data storage unit 610. When a print job is in the queue, the job control unit 611 refers to the print control unit 614 and determines whether print processing is feasible or not; when feasible, print data included in a print job that is at the top of the print queue in the data storage unit 610 is transferred to the image processing unit 612.

The image processing unit 612 performs various kinds of image processing to convert print data into a print image. A page of such a generated print image is transferred to the page memory 613. Upon detecting storage of such a print image in the page memory 613, the print control unit 614 gives an instruction to the printer engine 615 so as to print the contents of the page memory 613 on a recording material. Such image processing and expansion to the page memory 613 by the image processing unit 612 and such print processing by the printer engine 615 are repeated for all pages of print data in a print job, whereby a print request is processed.

On the other hand, the input/output control unit 606 acquires the status of an image forming apparatus from the equipment control unit 608, causes the screen generation unit 604 to generate a display screen based on the status, and then displays the generated display screen on the operation panel 605. Also, when the operation panel 605 provides notification of detection of a touch of a user's finger thereon, the input/output control unit 606 performs processing associated with a screen element, such as a button, that corresponds to the position where the user touched.

Functional Configuration of Non-Security-Equipped Image Forming Apparatus

Referring next to FIG. 6B, a non-security-equipped image forming apparatus is described. FIG. 6B illustrates a functional configuration of a non-security-equipped image forming apparatus according to the first exemplary embodiment. The term “non-security-equipped image forming apparatus” as used herein refers to an image forming apparatus that is incapable of interpreting access restriction information according to the present exemplary embodiment. Herein, only those components that are different from those in FIG. 6A are described. The same functional blocks as those in FIG. 6A are denoted by the same reference numerals and the descriptions thereof are omitted herein.

What is different from FIG. 6A is that a non-security-equipped image forming apparatus does not include the security control unit 616. In general, when such a non-security-equipped image forming apparatus receives the above-described ACT, problems occur such as abandonment of the data regarded as an invalid command and the resulting return of an error, misprinting, and the like. The present exemplary embodiment can solve such problems.

Process Flow for Client PC

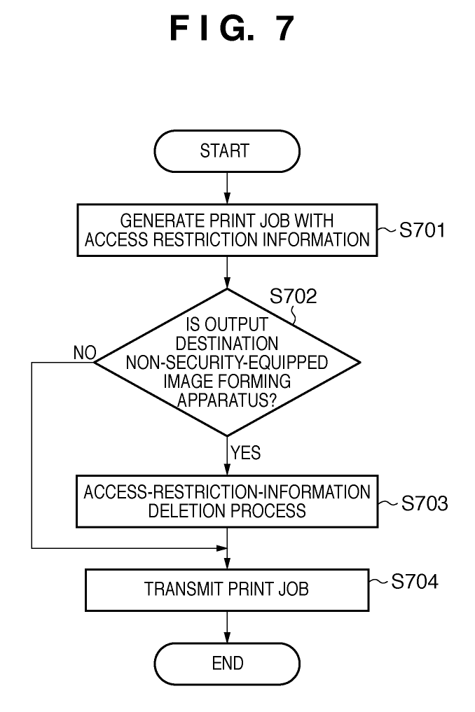

Next, a processing procedure of the client PC 101 when making a print request is described with reference to FIG. 7. FIG. 7 is a flowchart illustrating a processing procedure of the client PC 101 according to the first exemplary embodiment. The processing described below is centrally controlled by the CPU 201 of the client PC 101 loading a program stored in a memory into the RAM 202 and executing the program.

This flow starts when the CPU 201 of the client PC 101 receives a print request from a user. First, in step S701, the CPU 201 generates a print job with access restriction information. The access restriction information as referred to herein is described based on the premise that it was previously acquired from a user management server and stored on the HDD 212 of the client PC 101, but alternatively, it may be acquired from an image forming apparatus. Or, instead of being acquired previously, it may be acquired at the time of job execution.

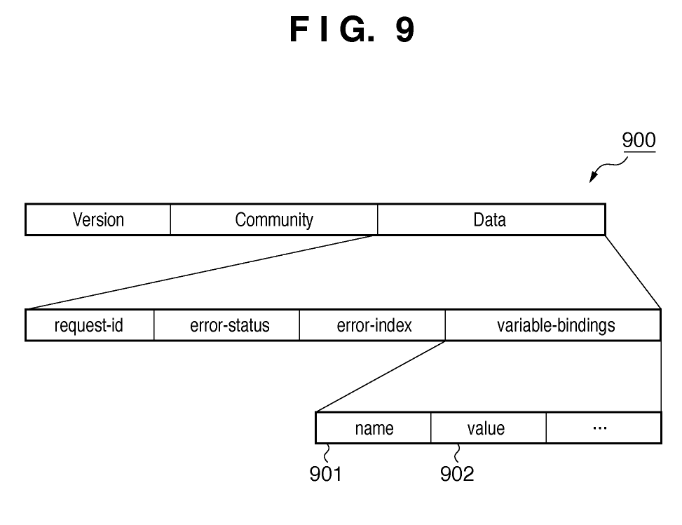

Then, in step S702, the CPU 201 determines whether or not the image forming apparatus designated as a print output destination is a non-security-equipped apparatus. The description is based on the premise that the determination method used at this time is a method of analyzing configuration information about each image forming apparatus that is previously stored on the HDD 212 of the client PC 101. Here, each piece of configuration information shall include at least the information illustrated in FIG. 9, which will be described later, or information equivalent thereto. Each piece of configuration information may be acquired from an image forming apparatus by transmitting an SNMP packet on an as-needed basis or may be acquired from an image-forming-apparatus management server (not shown).

When the result of determination in step S702 shows that the apparatus is a non-security-equipped image forming apparatus, the process goes to step S703; otherwise, the process goes to step S704. In step S703, the CPU 201 deletes access restriction information and stores a print job after such deletion in the print queue. More specifically, the CPU 201 interprets access restriction information, regenerates a print job into one that applies the access restriction information, and deletes the access restriction information. For instance, when a user who is not authorized to perform color printing issues a print job that requests color printing, color image data included in the print job is converted into monochrome image data. Further, for example for a user who is authorized only to perform N-in-1 printing (N pages of images are printed on a single sheet), image data included in a print job is scaled down so that N pages of images are joined together, forming a single page of image data. By doing so, even a non-security-equipped image forming apparatus becomes capable of performing such a print job that reflects the restriction contents of access restriction information. In other words, in the printing system 100 according to the present exemplary embodiment, when a non-security-equipped image forming apparatus performs printing, another apparatus (in the present example, the client PC 101) performs security processing as an alternative. However, there is a case where such conversion of image data by the client PC 101 is not sufficient enough depending on the contents of an ACT; in that case, an error message stating as such is displayed and the process is terminated at this point. When the conversion of image data by the client PC 101 is sufficient enough, then in step S704, the CPU 201 transmits the print job to the image forming apparatus, and the process is completed.

Process Flow for Non-Security-Equipped Image Forming Apparatus

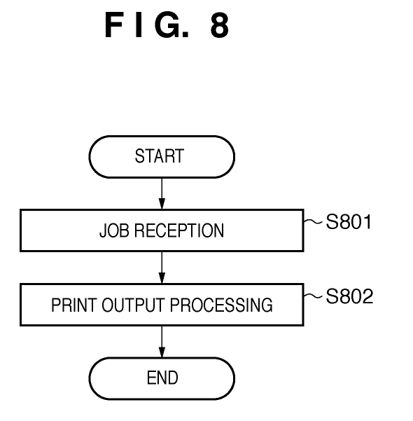

Next, a processing procedure of the non-security-equipped image forming apparatuses 103 and 104 at the time of printing is described with reference to FIG. 8. FIG. 8 is a flowchart illustrating a processing procedure of a non-security-equipped image forming apparatus according to the first exemplary embodiment. The processing described below is centrally controlled by the CPU 301 of each image forming apparatus 103 or 104 loading a program stored in the ROM 303 into the RAM 302 and executing that program.

First of all, a process starts when the CPU 301 of the image forming apparatus 103 or 104 accepts a request to receive a print job through the network communications control unit 305. In step S801, the CPU 301 receives a print job from the client PC 101. Then, in step S802, the CPU 301 performs print processing.

Search Packet and Response Packet

Described next referring to FIG. 9 are the structure of a search packet that is used to search for a security-equipped image forming apparatus as described above, and the structure of a response packet that is used as a response to such a search packet. FIG. 9 illustrates the structure of an SNMP packet according to the first exemplary embodiment. The packet described below is an SNMP packet that is transmitted to an image forming apparatus in order to determine whether or not the image forming apparatus is a non-security-equipped apparatus in step S702 in FIG. 7.

An SNMP packet 900 is composed of version, community, and data fields. When MIB information is acquired from an image forming apparatus, a GetRequest-PDU is used for the data field. In the data field, the variable-bindings field includes at least a name field 901 and a value field 902.

The client PC 101 transmits an OID that corresponds to MIB information, with the value field 902 set to NULL. Thus, a response packet that is transmitted correspondingly from an image forming apparatus is such that, when the value field 902 of the GetResponse-PDU is set to a value that corresponds to the name field 901, an error code is entered in the error-status field. Also when no specified OID exists, an error code is entered in the error-status field.

More specifically, the client PC 101 transmits, to an image forming apparatus, a GetRequest packet (search packet) that is an SNMP packet where the name field 901 contains an OID that represents MIB information about security functions. The client PC 101 then receives, from that image forming apparatus, a GetResponse packet (response packet) that is an SNMP packet received as a response. Now, for example when the error-status field contains “noSuchName” (“2”), the client PC 101 determines that the image forming apparatus is a non-security-equipped apparatus.

Print Job and ACT

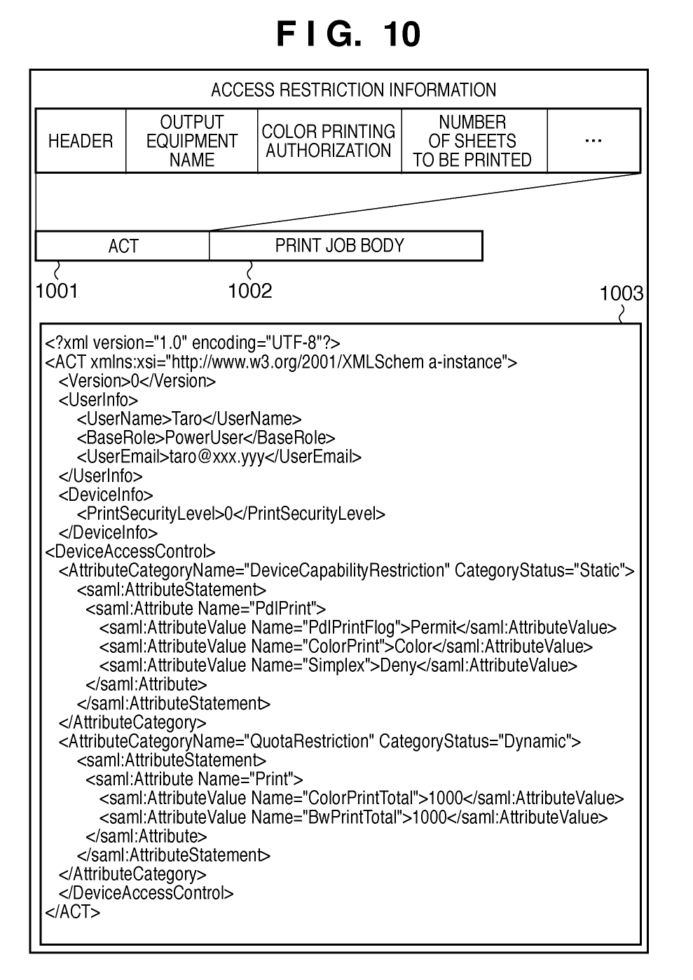

FIG. 10 shows an example of a job and an ACT that are output from a client PC to the outside. As illustrated in FIG. 10, an ACT 1001 is access restriction information that is assigned to a print job body 1002 and gives authorization to execute a print job or prohibits part of the execution. The ACT 1001 is described as being in the form of data as illustrated by 1003 and includes information such as a header, output equipment name that indicates an output destination of a print job, whether color printing is authorized or not, and the number of sheets of recording material that are authorized to be printed, and the like. An image forming apparatus that receives information with such an ACT 1001 assigned thereto interprets information from the ACT 1001 and performs a print job.

As described above, in the printing system according to the present exemplary embodiment, the information processing apparatus transmits a print job assigned access restriction information that indicates whether execution of a print job is authorized or not, only to an image forming apparatus that is capable of interpreting such access restriction information. On the other hand, when an image forming apparatus is incapable of interpreting access restriction information, the information processing apparatus deletes access restriction information, but reflects restriction contents in the data for the print job, and transmits a resultant print job. Thus, from among image forming apparatuses included in the printing system, even those without the function of interpreting access restriction information can flexibly restrict functions that are used at the time of execution of a print job. The client PC 101 performs control so as to prohibit the output of any print job other than those assigned an ACT or those reflecting restriction contents specified by the ACT. In this case, a scheme achieving such control is incorporated into application software that is capable of controlling a printer driver or the output of a printer driver. This prevents execution of an invalid print job.

### Second Exemplary Embodiment

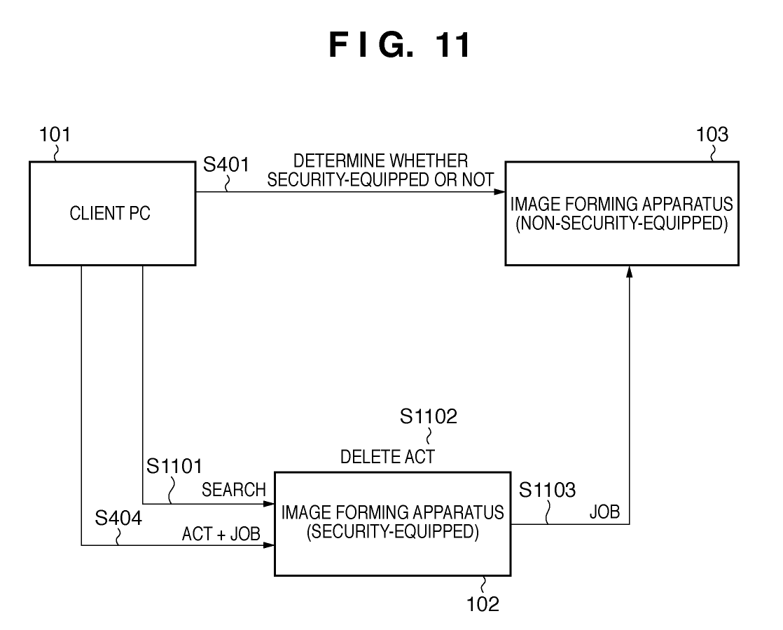

A second exemplary embodiment is described below with reference to FIGS. 11 to 13. The first exemplary embodiment describes an example where, in outputting a print job to the image forming apparatus 103 that is incapable of interpreting an ACT as in step S403 of FIG. 4, the client PC 101 itself reflects the contents of an ACT in the image data before output. However, in the present exemplary embodiment, the client PC 101 transfers a print job once to the image forming apparatus 102 that is capable of interpreting an ACT. The image forming apparatus 102 that receives such a print job performs an ACT deletion process and transmits a resultant print job to the image forming apparatus 103 that is designated as a final output destination (i.e., specified by a user to perform a print job) but incapable of interpreting an ACT.

Referring first to FIG. 11, the operation of the printing system 100 at the time of printing according to the present exemplary embodiment is described. FIG. 11 illustrates a flow of information among apparatuses in the printing system 100 according to the second exemplary embodiment. The same parts as those in FIG. 4 are designated by the same reference numerals and the descriptions thereof are omitted herein.

First, in step S401, the client PC 101 determines whether or not the output destination (a user-specified image forming apparatus) of a print job is an image forming apparatus that is capable of interpreting an ACT. When it is the image forming apparatus 103 that is incapable of interpreting an ACT, another image forming apparatus that is capable of interpreting an ACT is searched for in step S1101. One method of search used at this time is a method of acquiring configuration information about an image forming apparatus through broadcasting of an SNMP packet.

Then, in step S404, a print job assigned an ACT is transmitted once to the image forming apparatus 102 that is capable of interpreting an ACT and that was found by search processing in step S1101. The image forming apparatus 102 that receives a print job assigned an ACT interprets the ACT and searches for the output destination of the print job. As a result, when the output destination is another image forming apparatus 103, then in step S1102, the ACT deletion process is performed so as to delete the ACT assigned to the print job. Then, in step S1103, a print job obtained through the ACT deletion process is transmitted to the image forming apparatus 103.

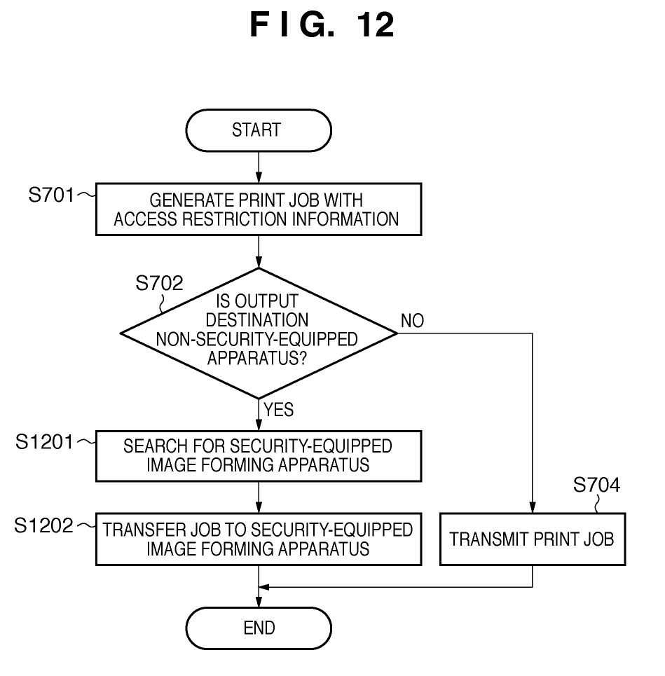

Then, a processing procedure of the client PC 101 when making a print request according to the present exemplary embodiment is described with reference to FIG. 12. FIG. 12 is a flowchart illustrating the processing procedure of the client PC 101 according to the second exemplary embodiment. The same steps as those in the flowchart of FIG. 7 are designated by the same step numbers and the descriptions thereof are omitted herein. Thus, steps S1201 and S1202 are described in the following. The processing described below is centrally controlled by the CPU 201 of the client PC 101 loading a program stored in a memory into the RAM 202 and executing that program.

In step S1201, that is, when the output destination (image forming apparatus) of a print job is a non-security-equipped apparatus, the CPU 201 searches for another image forming apparatus that is security-equipped. Then, in step S1202, the CPU 201 transfers the print job once to the security-equipped image forming apparatus found in step S1201.

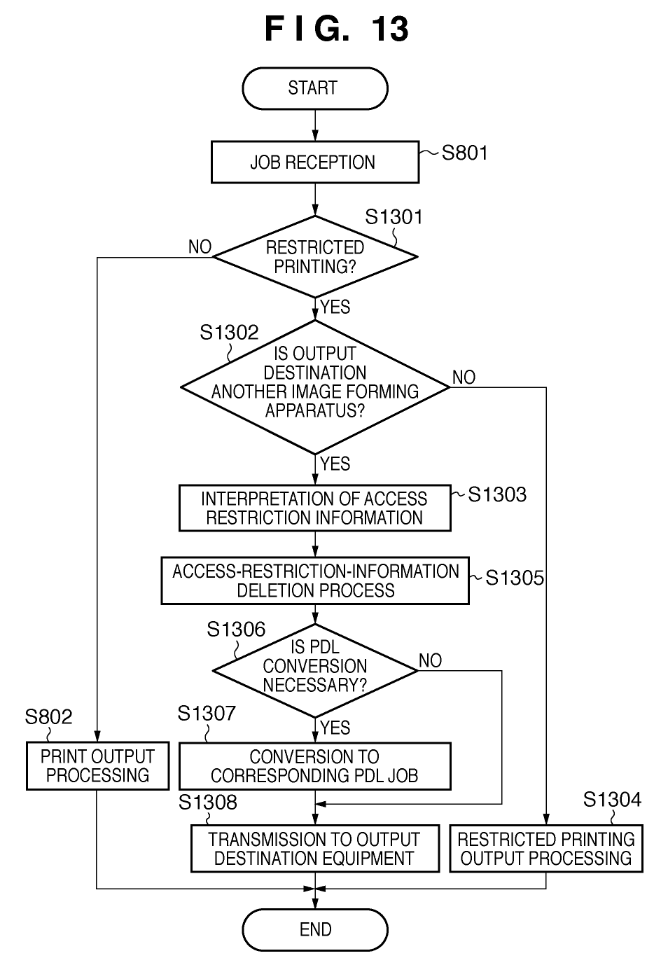

Next, a processing procedure of the security-equipped image forming apparatus 102 is described with reference to FIG. 13. FIG. 13 is a flowchart illustrating the processing procedure of the security-equipped image forming apparatus 102 according to the second exemplary embodiment. The same steps as those in the flowchart of FIG. 8 are designated by the same step numbers and the descriptions thereof are omitted herein. Thus, steps S1301 to S1308 are described in the following. The processing described below is centrally controlled by the CPU 301 of the image forming apparatus 102, 103 and 104 loading a program stored in the ROM 303 into the RAM 302 and executing that program.

In step S1301, the CPU 301 determines whether or not a received print job is a print job assigned access restriction information. As described above, if a print job has an ACT assigned thereto, it is determined as a restricted print job. When it is not a restricted print job, the process goes to step S802, where print processing is performed. On the other hand, when it is a restricted print job, the process goes to step S1302.

In step S1302, the CPU 301 determines whether or not the output destination of the print job is another image forming apparatus. The output destination of a print job is specified by an ACT. When the output destination of the print job is another image forming apparatus, the process goes to step S1303; otherwise, the process goes to step S1304. When the output destination of the print job is its own apparatus, then the CPU 301 performs print processing that is functionally restricted in step S1304, using the security function of the security-equipped image forming apparatus 102.

On the other hand, when the output destination of the print job is another image forming apparatus, then the CPU 301 interprets the ACT and acquires access restriction information in step S1303. Subsequently, in step S1305, the CPU 301 performs an access-restriction information deletion process. The term “access-restriction information deletion process” as used herein refers to processing for, based on the access restriction information interpreted in the above step S1303, regenerating a print job so that function restrictions are reflected therein and deleting the access restriction information. In other words, image data included in a print job is converted into data that reflects restriction contents specified by the ACT in the same manner as described above. If such conversion that reflects restriction contents specified by the ACT is complete enough, the process is terminated at this point.

Then, the CPU 301 determines whether PDL conversion is necessary or not in step S1306. This determination is implemented by, for example, transmitting an SNMP packet to an image forming apparatus designated as the output destination, thereby acquiring configuration information, and then detecting the PDL that is used in the image forming apparatus that is the output destination. When such conversion to a corresponding PDL is necessary, then in step S1307, the CPU 301 performs conversion processing of the data concerned. Further, in step S1308, the CPU 301 transmits the print job to the image forming apparatus that is the output destination.

As described above, when an image forming apparatus designated as the output destination of a print job does not have a function of interpreting access restriction information, the printing system according to the present exemplary embodiment searches for another image forming apparatus that is capable of interpreting access restriction information and transfers the print job to the apparatus found by the search. This prevents a print job assigned access restriction information from being transmitted to an image forming apparatus that does not have a function of interpreting such access restriction information.

### Third Exemplary Embodiment

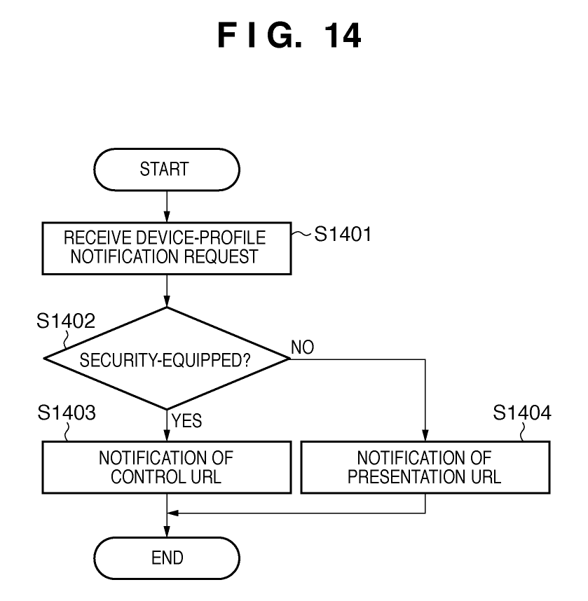

Next, a third exemplary embodiment is described with reference to FIG. 14. In the first and second exemplary embodiments, the client PC 101, at the time of execution of printing, determines whether or not the output destination of a print job is a security-equipped image forming apparatus, thereby preventing a print job assigned access restriction information from being transmitted to a non-security-equipped image forming apparatus. The present exemplary embodiment describes another method for preventing a print job assigned access restriction information from being transmitted to a non-security-equipped image forming apparatus.

FIG. 14 is a flowchart illustrating a processing procedure of an image forming apparatus at the time of transmission of a print job, according to the third exemplary embodiment. The processing described below is centrally controlled by the CPU 301 of the image forming apparatus 103 loading a program stored in the ROM 303 into the RAM 302 and executing that program.

In the following description, a WSD (Web Services on Devices) protocol is used as an example of a communications protocol for communications between the client PC 101 and the image forming apparatus 103. It is, however, noted that any other protocol may be applied instead. The WSD protocol is a protocol that comes standard with Windows® Vista and achieves new network connections, and is configured to facilitate detection (and/or installation) of multifunctional peripherals or printer devices, and data reception/transmission.

First of all, this process flow starts upon the CPU 301 of the image forming apparatus 103 receiving, via the network communications control unit 305, a request for notification of a device profile that includes information for requesting printing. The term “device profile” as used herein refers to a set of information necessary to control a device (in the present example, the image forming apparatus 103). More specifically, the device profile includes a presentation URL (a GUI for the device), a control URL (an entry to a control server or device command), an event subscription URL (event service registration for the device), a service control protocol description (a language used in the device), and the like. The presentation URL includes second identifying information for identifying second device information that restricts the use of specific functions of its own apparatus. More specifically, a receiving side that receives notification of such a presentation URL is enabled to identify, through this URL, device information (second identifying information) that restricts use of some device functions, so that it can use devices based on the premise that the use of some device functions is restricted by the device information. The control URL includes first identifying information for identifying first device information that allows use of specific functions of its own apparatus. More specifically, a receiving side that receives notification of such a control URL is enabled to identify, through this URL, device information (first identifying information) that allows use of specific device functions, so that it can use all device functions available from the device information. Examples of a notification request side that issues a request for notification of a device profile include the client PC 101 and another image forming apparatuses (e.g., the image forming apparatus 102).

According to a messaging specification for the current WSD protocol, a device (image forming apparatus) provides, for every requested control point, notification of a URL (control URL) that provides information for controlling the device. Upon notification of such a control URL, an apparatus that receives such notification identifies, through this URL, device information for controlling the device, so that it can gain entry to a control server or device command without any access control. In the present exemplary embodiment, notification of a control URL is provided only when the device-profile notification request side is a security-equipped image forming apparatus, which prevents a print job assigned access restriction information from being transmitted from the apparatus on the notification request side to a non-security-equipped image forming apparatus. Accordingly, available functions can be restricted on a user-by-user basis.

In step S1401, the CPU 301 receives a notification request for a device file. Then, in step S1402, the CPU 301 analyzes a received packet and determines whether or not the device-profile notification request side is a security-equipped image forming apparatus. When the notification request side is a security-equipped image forming apparatus, the process goes to step S1403; otherwise, the process goes to step S1404.

In step S1403, because the notification request side is a security-equipped image forming apparatus, the CPU 301 provides notification of a device profile that includes a control URL (that allows full control over a device). On the other hand, in step S1404, because the notification request side is a non-security-equipped image forming apparatus, the CPU 301 does not provide notification of a control URL, but provides notification of a device profile that includes a presentation URL that allows only restricted control. Examples of such a non-security-equipped image forming apparatus include, for example, the client PC 101 and the image forming apparatus 104. A receiving side that receives notification of a control URL changes the contents of a job according to the restriction contents specified by the ACT and then transmits the resultant job to an image forming apparatus. Thus, even though providing notification of a control URL to a security-equipped apparatus, the image forming apparatus can run a job while restricting the contents of processing that is performed in accordance with the restriction contents specified by the ACT, on a user-by-user basis. On the other hand, a non-security-equipped apparatus is provided with notification of a presentation URL; since the device information that can be specified by such a presentation URL is only restricted information, the executed contents of a specified job can be restricted. Accordingly, it is possible to restrict execution of a job using those functions of a non-security-equipped image forming apparatus that should not be used.

As described above, in the printing system according to the present exemplary embodiment, an image forming apparatus provides notification of a device profile that includes a control URL only when an apparatus on the device-profile notification request side is an image forming apparatus that is capable of interpreting access restriction information. And, it provides notification of a presentation URL when the notification request side is not an image forming apparatus that is capable of interpreting access restriction information. This allows the printing system according to the present exemplary embodiment to flexibly restrict the functions that are used at the time of execution of a print job, without providing notification of a print job assigned access restriction information assigned an image forming apparatus that does not have a function of interpreting access restriction information.

### Fourth Exemplary Embodiment

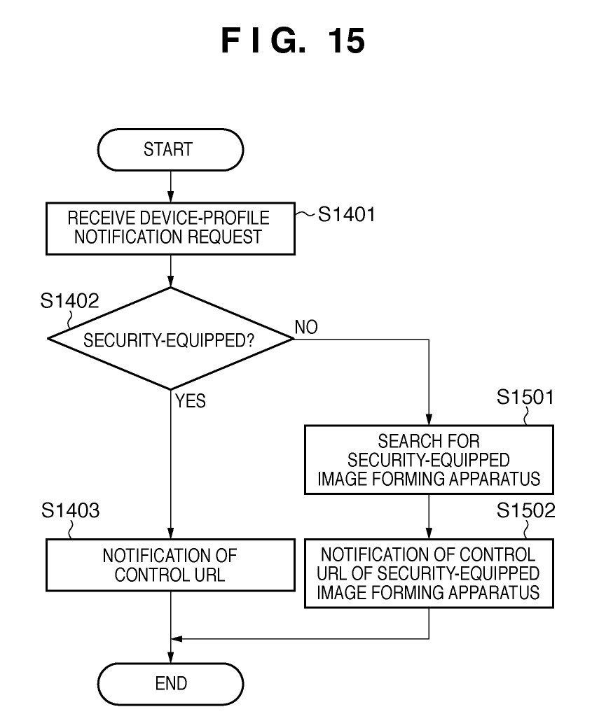

Next, a fourth exemplary embodiment is described with reference to FIG. 15. The third exemplary embodiment described the method of preventing a print job assigned access restriction information from being directly transmitted to a non-security-equipped image forming apparatus, by not providing notification of a control URL when the device-profile notification request side is a non-security-equipped image forming apparatus. In the present exemplary embodiment, when the device-profile notification request side is not a security-equipped image forming apparatus, a control URL of another security-equipped image forming apparatus is used for notification.

FIG. 15 is a flowchart illustrating a processing procedure of an image forming apparatus at the time of transmission of a print job according to the fourth exemplary embodiment. The processing described below is centrally controlled by the CPU 301 of the image forming apparatus 103 loading a program stored in the ROM 303 into the RAM 302 and executing that program. The same parts as those in FIG. 14 are designated by the same step numbers and the descriptions thereof are omitted herein. Thus, steps S1501 and S1502 are described in the following.

In the following description, as in the case of FIG. 14, the above-described WSD protocol is used as an example of a communications protocol for communications between the client PC 101 and the image forming apparatus 103. It is, however, noted that any other protocol may be applied to the present invention.

First, in step S1501, that is, when the apparatus is determined as not being a security-equipped image forming apparatus in step S1402, the CPU 301 searches for another security-equipped image forming apparatus within the network and acquires a control URL of that image forming apparatus. A search method as used herein may use information that has been previously stored in the data storage unit 610 of the image forming apparatus 103, or may use information that is acquired from an image-forming-apparatus management server not shown, or may acquire new information using a communications protocol such as WSD or the like. Then, in step S1502, the CPU 301 provides, to the apparatus on the notification request side, notification of a device profile that includes the control URL of the security-equipped image forming apparatus found in step S1501. The way of transmitting a job on the side that receives notification of each URL is similar to that described in the third exemplary embodiment.

As described above, in the printing system according to the present exemplary embodiment, an image forming apparatus provides notification of a device profile that includes a control URL only when an apparatus on the notification request side is an image forming apparatus that is capable of interpreting access restriction information. And, when the notification request side is not an image forming apparatus that is capable of interpreting access restriction information, another image forming apparatus that is capable of interpreting access restriction information is searched for and the control URL of that found image forming apparatus is used for notification. This allows the printing system according to the present exemplary embodiment to flexibly restrict functions that are used at the time of execution of a print job, without providing notification of a print job assigned access restriction information to an image forming apparatus that does not have a function of interpreting access restriction information. While the third and fourth exemplary embodiments have described examples using the WSD protocol, any other similar mechanism may be applied. For instance, instead of notification in the form of URLs, notification may be provided in the form of identifying information for identifying each piece of device information; or as another alternative, device information may be directly used for notification in response to a notification request for a device profile. That is, any form of notification is acceptable as long as the contents of a job to be executed can be restricted on a user-by-user basis.

In the above examples, a print job is described by way of an example of a job specified to be executed; however, the present invention is not limited thereto. For instance, a transmission job, such as facsimile transmission or electronic-mail transmission, for example, or any other kind of job is also applicable.

### Other Exemplary Embodiments

As described above, the object of the present invention can also be achieved by supplying a system or apparatus with a storage medium having recorded thereon program code of software for realizing the functionality of the above-described exemplary embodiments, and by a computer (a CPU, MPU, or the like) of the system or apparatus reading and executing the stored program code.

In this case, the actual program code read from the storage medium realizes the new functionality of the present invention, and the storage medium that stores the program code constitutes the present invention.

Accordingly, any mode of program, such as object code, a program executed by an interpreter, or script data supplied to an OS (operating system), is acceptable, as long as the functionality of the program is provided.

Examples of a storage medium for supplying the program include a flexible disk, a hard disk, an optical disk, a magneto-optical disk, an MO, a CD-ROM, a CD-R, and a CD-RW. Other examples include magnetic tape, a nonvolatile memory card, a ROM, and a DVD.

In this case, the actual program code read from the storage medium realizes the functionality of the above-described exemplary embodiments, and the storage medium that stores the program code constitutes the present invention.

Also, one method of supplying the program is a method of connecting to a website on the Internet using the browser of a client computer, and downloading the computer program of the present invention from the website to a recording medium such as an HDD. Alternatively, the program can be supplied by downloading a compressed file that includes an auto-install function to a recording medium such as a hard disk. Supply of the program can also be realized by splitting the program code constituting the program of the present invention into a plurality of files and downloading the respective files from different websites. In other words, the claims of the present invention also encompass a WWW server, ftp server, or the like that allows a plurality of operators to download program files for realizing the functionality and processes of the present invention with use of a computer.

Also, the program of the present invention can be distributed to operators as an encrypted program stored on a storage medium such as a CD-ROM. In this case, operators that satisfy a predetermined condition can be allowed to download decryption key information from a website via the Internet. The encrypted program is executed and installed on a computer using the key information, thereby realizing the functionality and processes of the present invention.

Also, in addition to a computer reading out and executing the program code, an OS or the like that is running on a computer can perform part or all of the actual processing based on instructions in the program code, thereby realizing the functionality and processes of the present invention.

Furthermore, the program code read from the storage medium can be written to a memory provided in a function expansion board inserted in a computer or a function expansion unit connected to a computer. In this case, a CPU or the like provided in the function expansion board or the function expansion unit performs part or all of the actual processing based on instructions in the program code, thereby realizing the functionality and processes of the present invention.

Also, the present invention may be applied to a system constituted from a plurality of apparatuses, or may be applied to an apparatus constituted from a single device. Also, needless to say, the present invention is applicable in a case where the functionality and processes of the present invention are achieved by supplying the program to a system or apparatus. In this case, the system or apparatus can benefit from the effects of the present invention by reading the storage medium that stores the program expressed by software for achieving the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-167875 filed on Jun. 26, 2008, which is hereby incorporated by reference herein in its entirety.

1. An information processing apparatus in an image processing system where the information processing apparatus and a plurality of image processing apparatuses are connected to one another via a network, the information processing apparatus comprising:
an assignment unit that assigns to a job restriction information, which restricts execution of the job by an image processing apparatus; and
a first control unit that (i) when an image processing apparatus has a function of interpreting the restriction information, transmits the job to which the restriction information is assigned to the image processing apparatus, and (ii) when an image processing apparatus does not have a function of interpreting the restriction information, modifies data for the job to reflect restriction contents of the restriction information and transmits the modified job to the image processing apparatus.

2. The information processing apparatus according to claim 1, wherein said first control unit includes:
a search unit that, when an image processing apparatus does not have a function of interpreting the restriction information, searches for another image processing apparatus that has a function of interpreting the restriction information from among the image processing apparatuses connected to the network; and
a transfer unit that transfers a job to which the restriction information is assigned to an image processing apparatus found by the search unit.

3. An image processing apparatus in an image processing system where an information processing apparatus and a plurality of image processing apparatuses are connected to one another via a network, said image processing apparatus comprising:
a reception unit that receives a request for a device profile that includes information for requesting execution of a job from another apparatus connected to the network; and
a control unit that (if when the another apparatus is an image processing apparatus that has a function of interpreting restriction information that restricts execution of a job, transmits to the another apparatus a device profile that includes first identifying information for identifying first device information that allows use of a specific function of said image processing apparatus, and (ii) when the another apparatus is not an image processing apparatus that has a function of interpreting the restriction information, transmits to the another apparatus a device profile that includes second identifying information for identifying second device information that restricts the use of the specific function of said image processing apparatus.

4. The image processing apparatus according to claim 3, wherein, when the another apparatus does not have a function of interpreting the restriction information, the control unit searches for another image processing apparatus that is capable of interpreting the restriction information within the network and transmits a device profile that includes the first identification information to the image processing apparatus found by the search, without transmitting a device profile that includes the second identifying information to the another apparatus.

5. A control method for an image processing system where an information processing apparatus and a plurality of image processing apparatuses are connected to one another via a network, the control method being performed by the information processing apparatus and comprising:
assigning restriction information to a job, which restricts execution of the job by an image processing apparatus; and
performing control so that (i) when an image processing apparatus has a function of interpreting the restriction information, thee job to which the restriction information is assigned is transmitted to the image processing apparatus, and (ii) when an image processing apparatus does not have a function of interpreting the restriction information, the data of thee job to which the restriction information is assigned is modified to reflect restriction contents of the restriction information and the modified job is transmitted to the image processing apparatus.

6. A control method for an image processing system where an information processing apparatus and a plurality of image processing apparatuses are connected to one another via a network, the control method being performed by a first image processing apparatus and comprising:
receiving a request for a device profile that includes information for requesting execution of a job, from another apparatus connected to the network; and
performing control so that (i) when the another apparatus is an image processing apparatus that has a function of interpreting restriction information that restricts execution of a job, a device profile that includes first identifying information for identifying first device information that allows use of a specific function of the first image processing apparatus is transmitted to the another apparatus, and (ii) when the another apparatus is not an image processing apparatus that has a function of interpreting the restriction information, a device profile that includes second identifying information for identifying second device information that restricts the use of the specific function of the first image processing apparatus is transmitted to the another apparatus.

7. A computer-readable storage medium storing a computer program that causes a computer to execute a control method for an information processing apparatus in an image processing system where the information processing apparatus and a plurality of image processing apparatuses are connected to one another via a network, the control method comprising:
assigning restriction information to a job, which restricts execution of the job by an image processing apparatus; and
performing control so that (i) when an image processing apparatus has a function of interpreting the restriction information, the job to which the restriction information is assigned is transmitted to the image processing apparatus, and (ii) when an image processing apparatus does not have a function of interpreting the restriction information, the data of the job to which the restriction information is assigned is modified to reflect restriction contents of the restriction information and the modified job is transmitted to the image processing apparatus.

8. A computer-readable storage medium storing a computer program that causes a computer to execute a control method for a first image processing apparatus in an image processing system where a plurality of image processing apparatuses are connected to one another via a network, the control method comprising:
receiving a request for a device profile that includes information for requesting execution of a job, from another apparatus connected to the network; and
performing control so that (i) when the another apparatus is an image processing apparatus that has a function of interpreting restriction information that restricts execution of a job, a device profile that includes first identifying information for identifying first device information that allows use of a specific function of the first image processing apparatus is transmitted to the another apparatus, and (ii) when the another apparatus is not an image processing apparatus that has a function of interpreting the restriction information, a device profile that includes second identifying information for identifying second device information that restricts the use of the specific function of the first image processing apparatus is transmitted to the another apparatus.
